(19) United States
(12) Patent Application Publication
(10) Pub. No.: US 2026/0076338 A1
(43) Pub. Date: Mar. 19, 2026

(54) ANIMAL ENCLOSURE AND REMOVABLE BREEDER OR LITTER BOX ASSEMBLY AND METHOD THEREOF

(71) Applicant: Mid-West Metal Products Company, Inc., Muncie, IN (US)

(72) Inventors: Stew Kerr, Muncie, IN (US); Michael Eric Greene, Muncie, IN (US); Scott Alan Henry, Albany, IN (US); David J. Nolley, Muncie, IN (US)

(21) Appl. No.: 19/328,712

(22) Filed: Sep. 15, 2025

Related U.S. Application Data
(60) Provisional application No. 63/695,036, filed on Sep. 16, 2024.

(51) Int. Cl. A01K 1/03; A01K 1/01

(52) U.S. Cl. CPC A01K 1/03; A01K 1/0107

(57) ABSTRACT

An animal enclosure assembly includes a plurality of members including at least a first member, a second member, a third member, and a fourth member. The first member, second member, third member, and fourth member are at least partially formed by a plurality of interconnected first plurality and second plurality of wires. The animal enclosure assembly also includes a door assembly movably coupled to one of the plurality of members and releasably coupled to another of the plurality of members. Each of the plurality of members includes a support frame formed by a plurality of support frame members. At least one support frame member has a first end and a second end such that the first end defines an opening configured to receive an end of another enclosure assembly and the second end forms a peg.

### FIELD OF THE DISCLOSURE

This application claims the benefit of U.S. Provisional Patent Application Ser. No. 63/695,036, filed Sep. 16, 2024, the disclosure of which is hereby incorporated by reference in its entirety.

### FIELD OF THE DISCLOSURE

The present disclosure relates to an enclosure assembly, and in particular to a enclosure assembly for coupling to another enclosure assembly for housing an animal.

### BACKGROUND

The use of animal cages is well known in the prior art. Many conventional cages have been developed over the years for housing animals of different sizes, and through the development of these cages flexibility and portability have become points of emphasis. Some conventional cages, for example, have been designed to collapse to a compact position for portability. Others have been designed of light weight and from durable materials. Conventional cages have been designed for ease of transporting an animal.

Most conventional cages include at least one door for providing access to the interior of the cage. An animal can enter or exit the cage through the opening when the door is opened, and the animal can be safely contained in the cage when the door is closed. Many conventional cages include a door that is attached to the cage via a hinge. This allows the door to be swung open and closed. A spring activated latch or the like have been incorporated into the design of the door to allow a user to open or lock the door.

Many of these conventional designs have limitations, however. For instance, the door that is hingedly attached to the cage can be swung open or closed too quickly and scratch or damage another object such as a wall or furniture. In addition, due to the hinged connection, the door cannot be partially opened, i.e., the door is either open or closed.

Other conventional cages have a limited volume. For example, a large conventional cage is ideally suited for a larger animal, whereas a smaller cage is ideally suited for a smaller animal. However, many conventional cages with a larger capacity may not be suitable for a smaller animal. Further, it is not possible to change or reduce the size of a larger cage to meet the needs of a smaller animal. In some instances, it may be desirable to couple multiple cages or enclosures to one another to form a larger enclosure.

Many of these conventional designs have limitations, however. For instance, many conventional cages are limited to solely housing an animal for a period of time. Other enclosures may be necessary for breeding or for housing litters.

Thus, there is a need for an animal enclosure assembly capable of being coupled to a breeder or litter box assembly.

### SUMMARY

In a first implementation of the present disclosure, an animal enclosure assembly includes a plurality of members defining an interior of the enclosure, the plurality of members including at least a first member, a second member, a third member, and a fourth member, where the first member, second member, third member, and fourth member are at least partially formed by a plurality of interconnected first plurality and second plurality of wires; and a door assembly movably coupled to one of the plurality of members and releasably coupled to another of the plurality of members; wherein, each of the plurality of members includes a support frame formed by a plurality of support frame members; wherein, at least one support frame member includes a first end and a second end, the first end defining an opening configured to receive an end of another enclosure assembly and the second end forming a peg configured to being received by the another enclosure assembly.

In one example, the first member includes a U-shaped wire; wherein the first plurality of wires of the first member includes a first wire and a second wire, the first and second wires being parallel to one another; wherein, the first wire and the second wire are coupled to the U-shaped wire. In a second example, the first wire and second wire form the U-shaped wire. In a third example, the U-shaped wire includes a first bend coupled to the first wire, a second bend coupled to the second wire, and a transverse portion coupled between the first bend and the second bend.

In a fourth example, the first member includes a first support frame member coupled to the first plurality of wires of the first member; wherein, the U-shaped wire is located below the first support frame member. In a fifth example, the transverse portion is located below and spaced outwardly from the first support frame member. In a sixth example, the transverse portion is perpendicular to the first wire and second wire. In a seventh example, the first member includes a second U-shaped wire; wherein the first plurality of wires of the first member includes a third wire and a fourth wire, the first and second wires being parallel to one another and the first and second wires; wherein, the third wire and the fourth wire are coupled to the second U-shaped wire; wherein the second U-shaped wire is spaced from the U-shaped wire.

In an eighth example, the third wire and fourth wire form the second U-shaped wire. In a ninth example, the first member forms a top member, the second member forms a bottom member, the third member forms a first side member, and the fourth member forms a second side member; wherein, the door assembly is movable between an open position and a closed position to selectively close a first opening formed by the top member, bottom member, first side member and second side member; wherein, the top member, bottom member, first side member and second side member form a second opening, the first opening spaced from the second opening; wherein an interior of the animal enclosure assembly is formed between the top member, bottom member, first side member, second side member, door assembly and second opening.

In a tenth example, the plurality of members includes a fifth member coupled to the first member, second member, third member, and fourth member, the fifth member being spaced from the door assembly; wherein, the fifth member defines an opening configured to being coupled to an interior of another enclosure assembly. In an eleventh example, the second member includes a first support frame member, the first support frame member defining at least one opening configured to receive a wire of another animal enclosure. In a twelfth example, the first support frame member forms at least a second opening configured to receive a peg from the another animal enclosure.

In another example, each of the plurality of interconnected first plurality and second plurality of wires is coupled to one or more of the plurality of support frame members of the support frame. In yet another example, the plurality of members form a breeder box assembly or a litter box assembly configured to being coupled to another animal enclosure.

In a further implementation of the present disclosure, an enclosure assembly includes an animal enclosure assembly including a first plurality of members including a top member, a bottom member, a first side member, a second side member, a front member, and a back member, the first plurality of members formed by a first plurality of interconnecting wires to define an interior of the animal enclosure assembly; and a box enclosure assembly including a second plurality of members including at least a first member, a second member, a third member, a fourth member, and a door assembly member, where the second plurality of members are formed by a second plurality of interconnecting wires to define an interior of the box enclosure assembly; wherein, each of the second plurality of members includes a support frame formed by a plurality of support frame members; wherein, the box enclosure assembly is coupled to the animal enclosure assembly such that the interior of the box enclosure assembly is directly connected to the interior of the animal enclosure assembly.

In a first example of this implementation, a first support frame member of the plurality of support frame members includes a first end and a second end, the first end defining an opening configured to receive one of the first plurality of members of the animal enclosure assembly and the second end forming a peg configured to being received by an opening formed in another member of the first plurality of members of the animal enclosure assembly.

In a second example, the first member of the box enclosure assembly includes a U-shaped wire; wherein the first plurality of wires of the first member includes a first wire and a second wire, the first wire and the second wire are coupled to the U-shaped wire; wherein, one of the first plurality of members of the animal enclosure assembly is positioned on top of and in contact with the U-shaped wire when the box enclosure assembly is coupled to the animal enclosure assembly.

In another example, the second member of the box enclosure assembly includes a first support frame member, the first support frame member defining at least one opening configured to receive a wire of the animal enclosure assembly when the box enclosure assembly is coupled to the animal enclosure assembly. In a further example, the first support frame member forms at least a second opening configured to receive a peg from the one of the first plurality of members of the animal enclosure assembly.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 is one implementation of a perspective view of a multi-level animal enclosure assembly with a breeder or litter box assembly;

FIG. 2 is another implementation of a perspective view of a multi-level animal enclosure assembly with a breeder or litter box assembly;

FIG. 3 is one implementation of a front perspective view of a breeder or litter box assembly;

FIG. 4 is a rear perspective view of a breeder or litter box assembly;

FIG. 5 is one implementation of a top member of the breeder or litter box assembly of FIGS. 3-4 being coupled to another enclosure assembly;

FIG. 6 is an exploded perspective view of the top member and the other enclosure assembly of FIG. 5; and

FIG. 7 is a partial perspective view of the bottom member of the breeder or litter box assembly of FIGS. 3-4 being coupled to another enclosure assembly; and

FIG. 8 is an exploded perspective view of the bottom member and the other enclosure assembly of FIG. 7.

Corresponding reference numerals are used to indicate corresponding parts throughout the several views.

### DETAILED DESCRIPTION

The implementations of the present disclosure described below are not intended to be exhaustive or to limit the disclosure to the precise forms disclosed in the following detailed description. Rather, the implementations are chosen and described so that others skilled in the art may appreciate and understand the principles and practices of the present disclosure.

The present disclosure relates to an enclosure assembly. The enclosure assembly may be a single enclosure assembly or a plurality of enclosure assemblies. In one implementation, the enclosure assembly is formed of wire of a one or more diameters. In other implementations, the enclosure assembly is formed by a plurality of interconnected horizontal and vertical wires. In some implementations, the plurality of enclosure assemblies may include a plurality of wire enclosures each formed by interconnected horizontal and vertical wires. In other implementations, the enclosure assembly may be formed by interconnected wires, but the interconnected wires may or may not be horizontally and/or vertically oriented. In yet other implementations, the enclosure assembly may include some portions of interconnected wires and other portions formed of aluminium, plastic, steel, or other known material.

The enclosure assembly or plurality of enclosure assemblies can be used for multiple purposes, one of which is to contain animals. The enclosure assembly or plurality of enclosure assemblies can be made of any size for accommodating an object of any size. In some implementations, the enclosure assembly may be formed for coupling to another enclosure assembly for increasing an internal volume capable of housing a larger object (e.g., an animal) or a plurality of objects (e.g., multiple animals). In several implementations where there are a plurality of enclosure assemblies, each enclosure assembly may be the same size and shape. In yet other implementations where there are a plurality of enclosure assemblies, at least one enclosure assembly may be a different size and/or shape than another enclosure assembly.

In some implementations, the enclosure assembly may be a breeder box or litter box which may be coupled to another enclosure assembly. The present disclosure provides one or more implementations of a breeder box or litter box assembly.

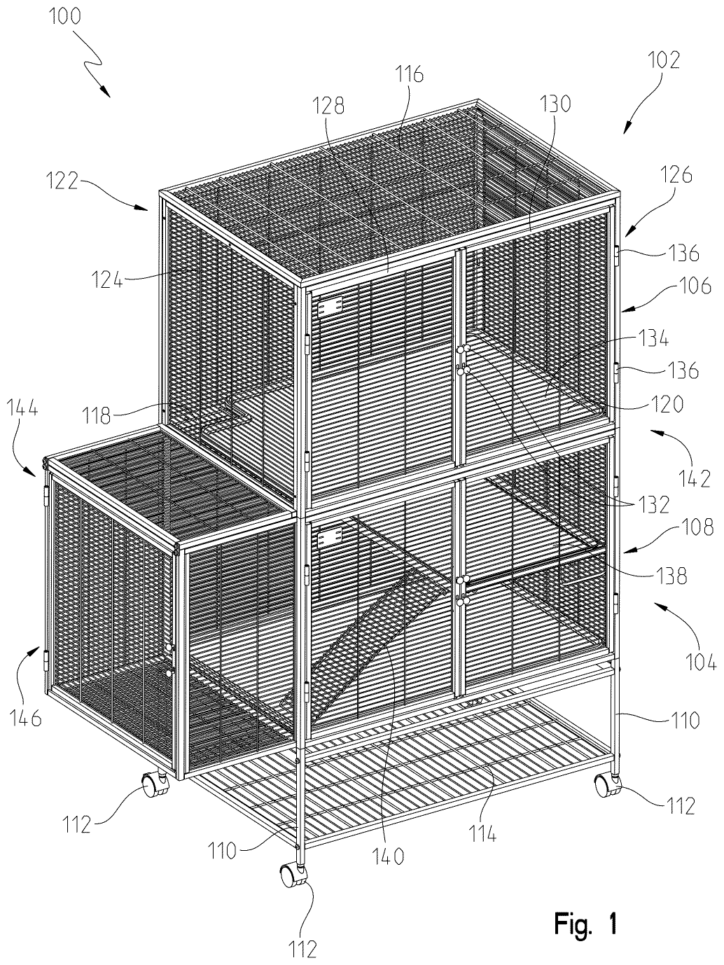

Referring to FIG. 1, one implementation of an animal enclosure in the form of a multi-enclosure assembly 100 of the present disclosure is shown. In this implementation, the multi-enclosure assembly 100 may be formed substantially of interconnected wires and is shown including at least a first enclosure 106 and a second enclosure 108. The multi-enclosure assembly 100 may include a top 102 and a bottom 104 where at the top 102 may be the first enclosure 106 and towards the bottom 104 is the second enclosure 108. In the illustrated implementation, the first enclosure 106 may be located directly above the second enclosure 108. In another implementation, the first enclosure 106 may be located above the second enclosure 108, but not directly above. In a further implementation, the first enclosure may be above and offset from the second enclosure. In yet another implementation, the first enclosure 106 may be located adjacent to the second enclosure 108. In yet a further implementation, the first enclosure 106 may be partially above the second enclosure 108. Other arrangements or configurations of the first and second enclosures may be possible in different implementations, but are contemplated in this disclosure.

In some implementations, the first and second enclosures may be further supported by a plurality of support legs 110. In FIG. 1, a plurality of support legs 110 includes a first end and a second end. The first end of each support leg 110 may be coupled to either the first or second enclosure, whereas the second end may be coupled to a wheel or caster 112. In this implementation, the multi-enclosure assembly 100 is transportable as the casters 112 roll along a surface such as a ground or floor. One or more of the casters 112 may be configured in a locked state or unlocked state. In an unlocked state, the caster 112 may be free to roll or rotate about a rotational axis. In a locked state, the caster 112 may be held or prevented from rolling or rotating.

In one implementation, a shelf 114 may be coupled to the plurality of support legs 110. In the arrangement shown in FIG. 1, the shelf 114 may be located below the second enclosure 108 but above the casters 112. In some implementations, the shelf 114 may be located closer to the casters to enable larger items to be stored on the shelf 114 compared to if the shelf 114 were closer to the second enclosure 108. The shelf 114 may be formed of wire. In one implementation, the wire may be arranged as a plurality of interconnected wires. The shelf 114 may be sized such that it is approximately the same width and depth as the first and second enclosures. In other implementations, the shelf 114 may be smaller than the first and second enclosures. In other implementations, the shelf 114 may include multiple shelves. In other implementations, another shelf 114 may be located between the first and second enclosures.

Referring to FIG. 1, the first enclosure 106 may include a top member 116, a bottom member 118, a front member 120, a back member 122, a first side member 124 and a second side member 126. The first and second side members may be oppositely disposed from one another. In this implementation, the front member 120 can include a door assembly. In other implementations, the first side member 124, second side member 126, or back member 122 may also include a door assembly. Each of the members may be formed by a plurality of interconnecting wires.

Although not shown, the top member 116 and bottom member 118 may include one or more pegs or pins protruding therefrom. The one or more pegs or pins may project downward from a bottom surface of the top member 116 such that each of the one or more pegs or pins may be located within an opening formed in the first side member 124, second side member 126, front member 120 and/or back member 122. As the pegs or pins are inserted into the corresponding openings, the top member 116 may be coupled to the corresponding member. In the same way, the bottom member 118 may include one or more pegs or pins protruding from a top surface thereof. Each of the one or more pegs or pins on the bottom member 118 may be inserted into a corresponding opening formed in the first side member 124, second side member 126, front member 120 and/or back member 122. As such, the bottom member 118 may be coupled to the corresponding first side member 124, second side member 126, front member 120 and/or back member 122 upon the connection of the peg or pin within the opening.

In one implementation, the first side member 124, second side member 126, front member 120 and/or back member 122 may include an opening formed at each corner thereof. In the same way, the top member 116 and bottom member 118 may include a peg or pin protruding therefrom at each corner thereof. The insertion of each peg or pin in the corresponding openings enables the first enclosure 106 to be assembled.

In other implementations, one or more latches may be used for coupling the different members to one another. For example, the front member 120 may be coupled to the first side member 124 and second side member 126 via one or more latches.

In one implementation, the door assembly may include a first door 128 and a second door 130. Each door may be pivotally coupled to the front member 120 via one or more hinges 136. Each of the first door 128 and second door 130 may be opened independently of the other. Each door may include its own latch or locking mechanism 132 for maintaining the door in its closed position.

In some implementations, a pan 134 may be positioned inside the first enclosure 106 and rest against the bottom member 118. The pan 134 may be approximately the same size as the bottom member 118, although in some implementations the pan 134 may differ in size from the bottom member 118.

In other implementations, a shelf 138 may be located in the first enclosure 106 and/or the second enclosure 108. In FIG. 1, a shelf 138 is shown located in the second enclosure 108. The shelf 138 may be formed of a plurality of interconnecting wires similar to the other members of the second enclosure 106. A corresponding pan may be placed on top of the shelf 138 or coupled thereto.

In one implementation, a ramp 140 may be disposed between the shelf 138 and the bottom member 118 or pan 134. The ramp 140 may be configured as a step or plurality of steps formed of wire as shown in FIG. 1, or it may be configured as a generally flat body. The ramp 140 may be coupled to the shelf 138. For example, the ramp 140 may be formed including a pair of elongate wires that extend the length of the ramp. Each end of the pair of elongate wires may include a hooked end of the respective wire for engaging a corresponding wire or surface of the shelf 138.

In some implementations, the first enclosure 106 and/or second enclosure 108 may include one or more shelves 138. There may be a ramp 140 for each shelf 138. In some instances, a ramp 140 may be coupled between shelves 138 to allow an animal to move between shelves 138.

In the implementation of FIG. 1, the second enclosure 108 may be arranged similar to the first enclosure 106. In other words, the second enclosure 108 may include a top member 116, a bottom member 118, a front member 120, a back member 122, a first side member 124 and a second side member 126. The second enclosure 108 may include a door assembly formed in one of the members, and the door assembly may include a first door 128 and a second door 130. Moreover, in some implementations, the second enclosure 108 may include a pan 134, one or more shelves 138, and one or more ramps 140. In at least one implementation, an opening may be formed between the first and second enclosure to provide access therebetween. In this manner, the pan 134 in the first enclosure 106 may include a cut-out to allow an animal to travel therebetween along a ramp (not shown).

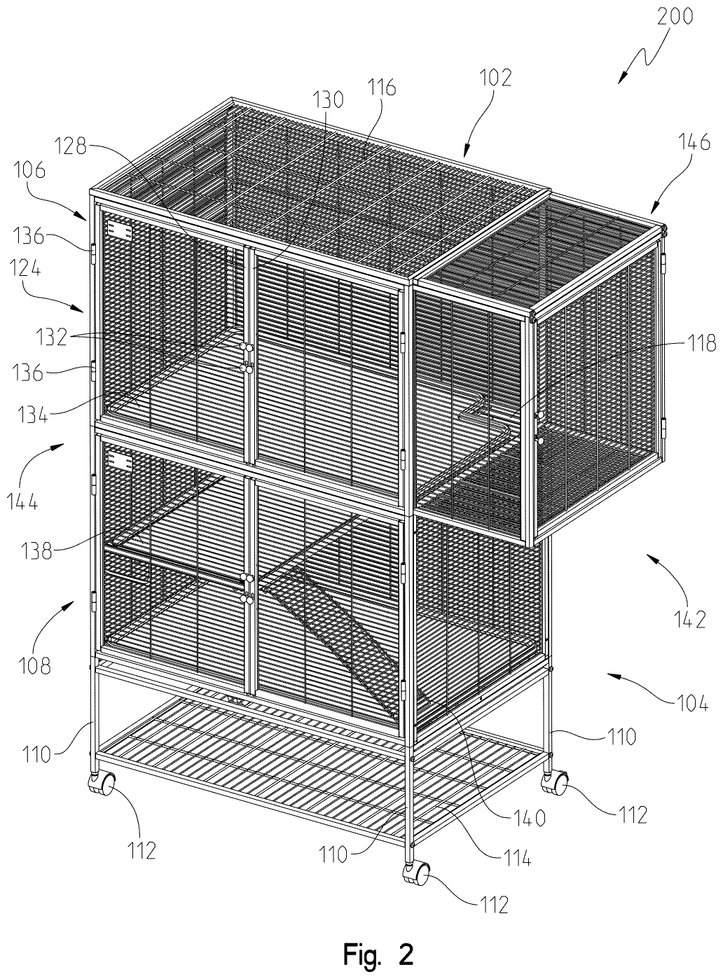

In the implementation illustrated in FIG. 1, another enclosure assembly 146 may be coupled to either a first side 142 or a second side 144 of the multi-enclosure assembly 100. As shown in FIG. 1, the enclosure assembly 146 may be similar to each of the first enclosure 106 and second enclosure 108 in terms of material and arrangement. In some implementations, the enclosure assembly 146 may be smaller in size than the first and second enclosures. In several implementations, the enclosure assembly 146 may be configured as a breeder box assembly or a litter box assembly. As shown, the enclosure assembly 146 may be coupled to either the first enclosure 106 or the second enclosure 108 of the multi-enclosure assembly 100. In FIG. 1, for example, the enclosure assembly 146 is shown coupled to a second side 144 of the second enclosure 108. Referring to FIG. 2, another implementation of a multi-enclosure assembly 200 is illustrated in which the enclosure assembly 146 is coupled to a first side 142 of the first enclosure 106. In other implementations, the enclosure assembly 146 may be coupled to the second side 144 of the first enclosure 106 or the first side 142 of the second enclosure 108. In other implementations, the enclosure assembly 146 may be coupled to only a single enclosure assembly rather than a multi-enclosure assembly as shown in FIGS. 1 and 2.

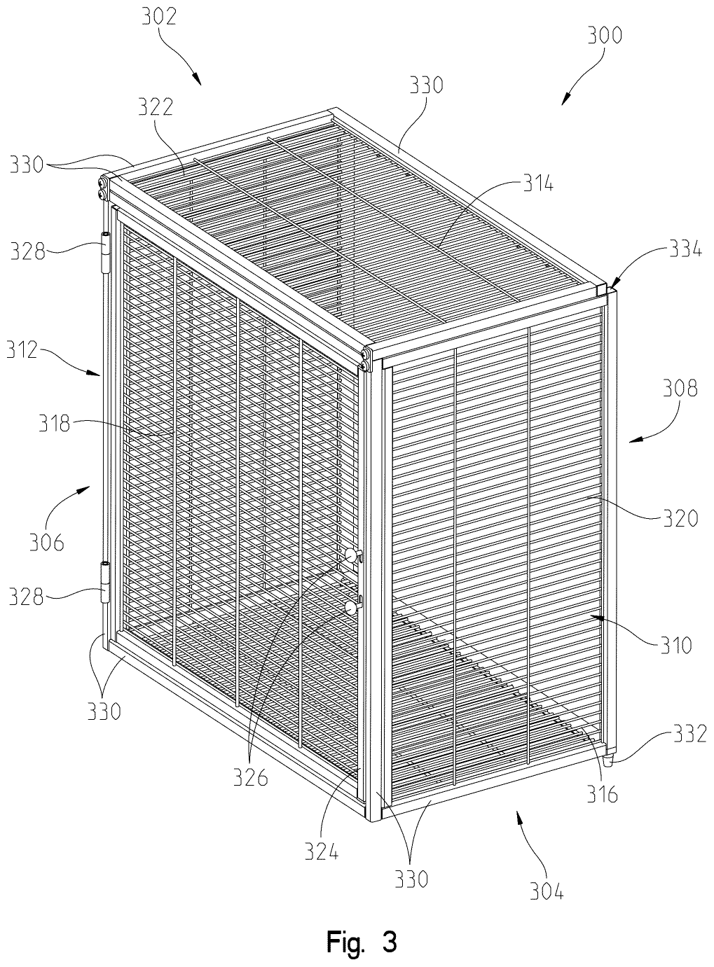

Turning now to FIG. 3 of the present disclosure, one implementation of an enclosure assembly 300 in the form of a breeder box or litter box assembly is shown. The enclosure assembly 300 may be similar to the enclosure assembly 146 of FIGS. 1 and 2. In FIG. 3, for the sake of orientation, the enclosure assembly 300 is configured as a structure having a top 302, a bottom 304, a front side 306, a back side 308, a first side 310, and a second side 312.

In the implementation of FIG. 3, the enclosure assembly 300 may include at least a top member 314, a bottom member 316, a front member 318, a first side member 320, and a second side member 322. In this implementation, the enclosure assembly 300 is not shown having a back member as the back member is removed to enable the enclosure assembly 300 to be coupled to another enclosure assembly such as the first enclosure assembly 106 or second enclosure assembly 108. In other implementations, however, a back member may be provided with an opening formed therein through which an animal may pass from the interior of the enclosure assembly 300 to another enclosure such as the first enclosure assembly 106 or second enclosure assembly 108. For example, the back member (or any other member) may include a plurality of interconnecting wires (e.g., horizonal and vertical interconnecting wires) that form the opening.

In other implementations, the enclosure assembly 300 may include a back member. In order to couple the enclosure assembly 300 to another enclosure assembly, the top member 314, the bottom member 316, the first side member 320, or the second side member 322 may be removed for coupling to the other enclosure. In several implementations, the front member 318 may be removably coupled to the enclosure assembly 300. In some implementations, each of the top member 314, bottom member 316, front member 318, back member, first side member 320, and second side member 322 may be removably coupled to the enclosure assembly 300 to enable the enclosure assembly 300 to be coupled along any side thereof to another enclosure assembly. In one implementation, two or more of the top member 314, bottom member 316, front member 318, back member, first side member 320, and second side member 322 may be removed from the enclosure assembly 300 to allow the enclosure assembly to be coupled to two or more other enclosure assemblies.

In the implementation of FIG. 3, the enclosure assembly 300 may also include a door assembly for accessing an interior of the enclosure assembly 300 when coupled to another enclosure assembly. The door assembly may include a door 324 that is pivotally coupled to the front member 318 via one or more hinges 328. The door 324 may include its own latch or locking mechanism 326 for releasably locking the door 324 in its closed position.

The enclosure assembly 300 of FIG. 3 is also shown having a support frame 330. The support frame 330 may include a plurality of support frame members. In one implementation, each of the top member 314, bottom member 316, front member 318, back member, first side member 320, and second side member 322 may include a support frame 330. For example, each of the top member 314, bottom member 316, front member 318, back member, first side member 320, and second side member 322 may be formed by a plurality of interconnecting wires that forms a grid-like structure. The plurality of interconnecting wires may be coupled at each end thereof to the support frame. Thus, for a given member of the enclosure assembly 300 such as the top member 314, the top member 314 may be a four-sided structure with support frame 330 on each side. Each of the plurality of interconnecting wires may include opposite ends such that each end of each of the plurality of interconnecting wires is coupled to a corresponding support frame member of the support frame 330. The same may be the case for each of the top member 314, bottom member 316, front member 318, back member, first side member 320, and second side member 322. Further, each of the top member 314, bottom member 316, front member 318, back member, first side member 320, and second side member 322 are shown as having up to four sides, and in each case the support frame 330 for each of member may have the same number of support frame members as sides of the respective member (e.g., bottom member, front member, etc.).

In the implementation of FIG. 3, the enclosure assembly 300 is illustrated without a back member. Instead, the first side member 320 is shown including a peg 332 at a lower portion thereof as well as a opening 334 defined in the support frame 330 of the first side member 320. Although not shown in FIG. 3, the second side member 322 may also include a peg 332 and an opening 334 defined in the support frame 330. As will be described below and as partially shown in FIGS. 1-2, the other enclosure assembly such as the first enclosure 106 or second enclosure 108. These other enclosures may include corresponding pegs for being positioned within the opening 334 as well as a corresponding opening for receiving the peg 332 when coupling to the enclosure assembly 300.

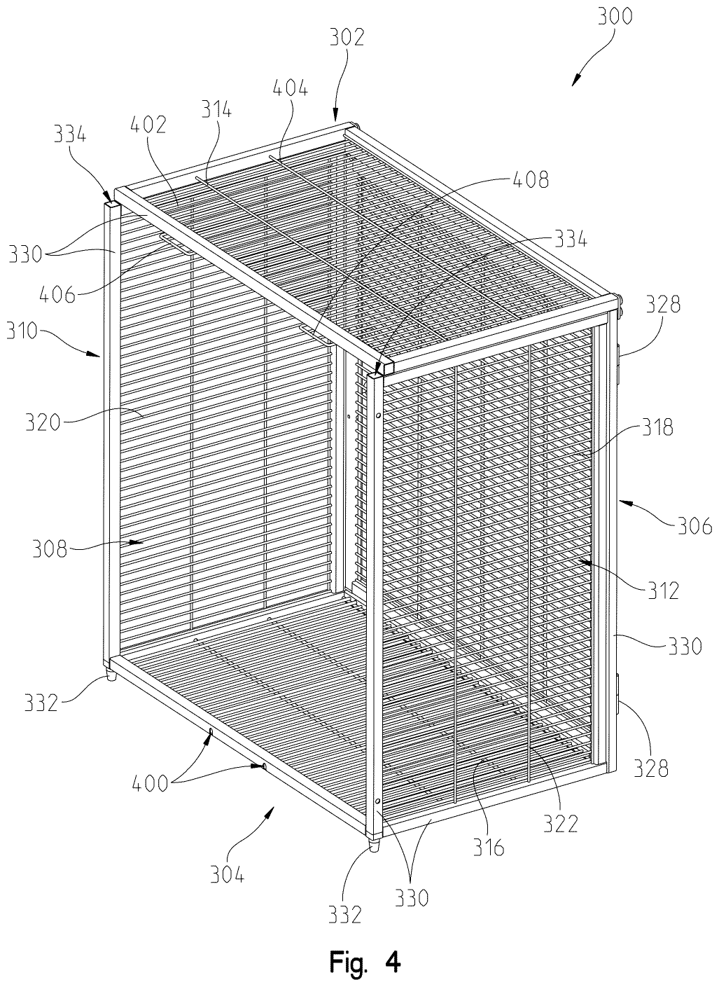

Referring to FIG. 4, the enclosure assembly 300 is shown with the back member being absent. The pegs 332 and openings 334 are better shown in the first side member 320 and second side member 322. The interior or cavity formed by the other members of the enclosure assembly 300 is also shown.

The bottom member 316 is shown in FIG. 4 as including one or more openings 400 formed in the support frame 330. These openings 400 may be arranged for receiving one or more wires (not shown) from an adjacent enclosure assembly for coupling to the enclosure assembly 300.

With respect to the top member 314, the top member 314 is shown being formed by a first plurality of wires 402 and a second plurality of wires 404. The first and second plurality of wires may be interconnected with one another to form a grid-like structure. In some implementations, the first plurality of wires 402 may be disposed generally perpendicular to the second plurality of wires 404. As shown, the first and second plurality of wires may be coupled at each end to the support frame 330.

As also shown in FIGS. 4-6, one or more U-shaped wires may be coupled to the top member 314. In FIG. 4, for example, a first U-shaped member 406 and a second U-shaped member 408 may be coupled to the top member 314. As will be described shortly, the first and second U-shaped wires may be coupled to an adjacent enclosure assembly for securely coupling the breeder box or litter box assembly to the adjacent enclosure assembly.

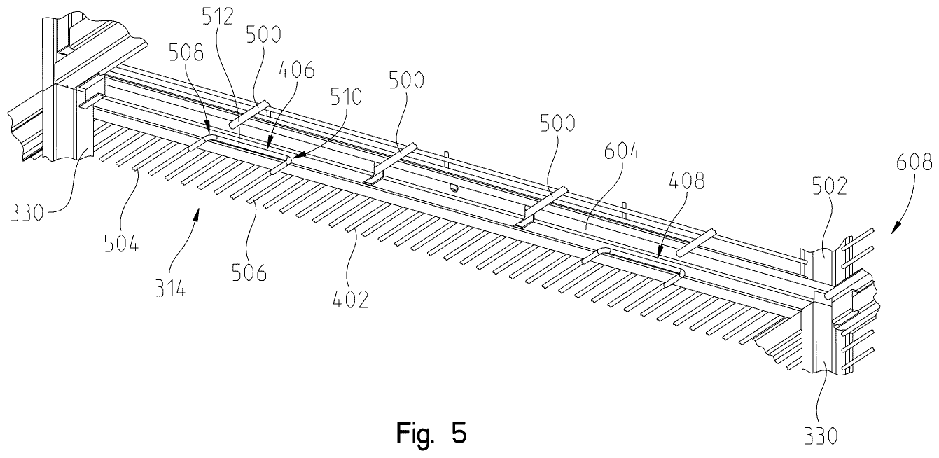

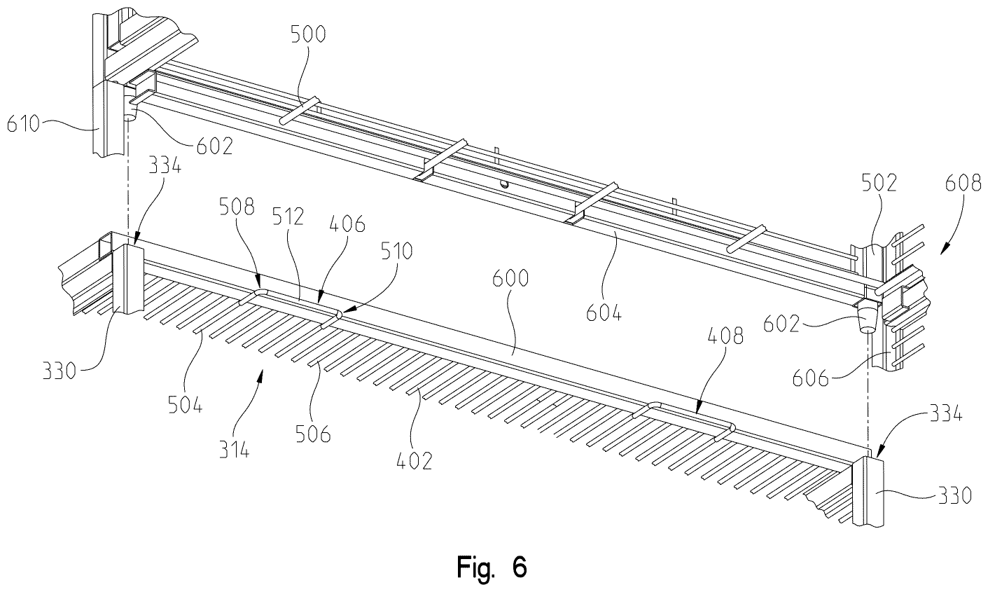

In FIGS. 5 and 6, the top member 314 is shown being coupled to another enclosure assembly 608. The second or other enclosure assembly 608 may include various members such as those described with respect to the first enclosure 106 and the second enclosure 108 in FIGS. 1 and 2. The second enclosure 608 may include a plurality of wires 500 coupled to a support frame having a first support frame member 502, a second support frame member 604, a third support frame member 606, and a fourth support member 610. The first support frame member 502 may include a peg 602 protruding therefrom and configured to be received within an opening formed in the support frame 330 of the enclosure assembly 300. For example, the peg 602 may be received within one of the openings 334 formed in the support frame 330 when coupling the enclosure assembly 300 to the second enclosure assembly 608.

In FIG. 6, the first U-shaped member 406 and the second U-shaped member 408 are shown. In one implementation, each U-shaped member may be a single wire. In another implementation, each U-shaped member may be one or more wires. In a further implementation, each U-shaped member may be formed of plastic. In yet a further implementation, each U-shaped member may be formed of aluminum or steel. Other materials may be utilized for forming the U-shaped member.

In the implementation of FIG. 6, the first U-shaped member 406 is shown in more detail. The first U-shaped member may includes a first portion 504 and a second portion 506. The first portion 504 and second portion 506 may be coupled to one of the first plurality of wires 402 or second plurality of wires 404 of the top member 314. In some implementations, the first portion 502 and second portion 506 may be part of the same wire that forms the U-shaped member 406. In other implementations, the first portion 504 may be part of a first wire and the second portion 506 may be part of a second wire, where the first and second wires are coupled (e.g., welded) to one another.

The first portion 504 may terminate at a first bend 508 as shown in FIG. 6. Likewise, the second portion 506 may terminate at a second bend 510. In some implementations, the first and second portion may be generally straight wires from an end thereof to the first and second bends, respectively. The first U-shaped member 406 may include a transverse portion 512 that extends between the first bend 508 and the second bend 510. In one implementation, the transverse portion 512 may be at least partially perpendicular to the first portion 504 and the second portion 506.

In FIG. 6, the top member 314 includes the support frame 330 including support frame member 600. In the illustrated implementation, at least the first bend 508, second bend 510, and transverse portion 512 may be located partially below the support frame member 600. In other words, a bottom surface of the support frame member 600 may be disposed at a location above the first bend 508, the second bend 510, and the transverse portion 512. Further, the first bend 508, second bend 510, and transverse portion 512 may be positioned offset longitudinally from the support frame member 600. In other words, the U-shaped member 406 may protrude outwardly from the enclosure assembly 300 such that the first bend 508, the second bend 510, and the transverse portion 512 are offset outwardly from the support frame member 600. With this arrangement, and as shown in FIG. 5, the first U-shaped member 406 and the second U-shaped member 408 may be positioned below the second support frame member 604 of the second enclosure assembly 608. In this arrangement, the top member 314 is held in place relative to the second enclosure 608 without being dislodged or moved out of its position as shown. In other words, an animal contained within the enclosure assembly 300 may not lift the top member 314 and decouple the top member 314 from the enclosure assembly 300 or the second enclosure assembly 608.

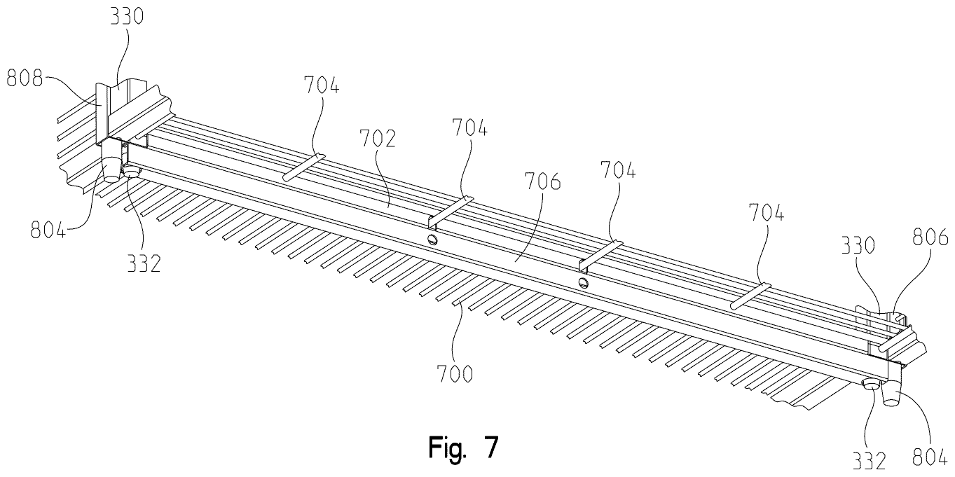

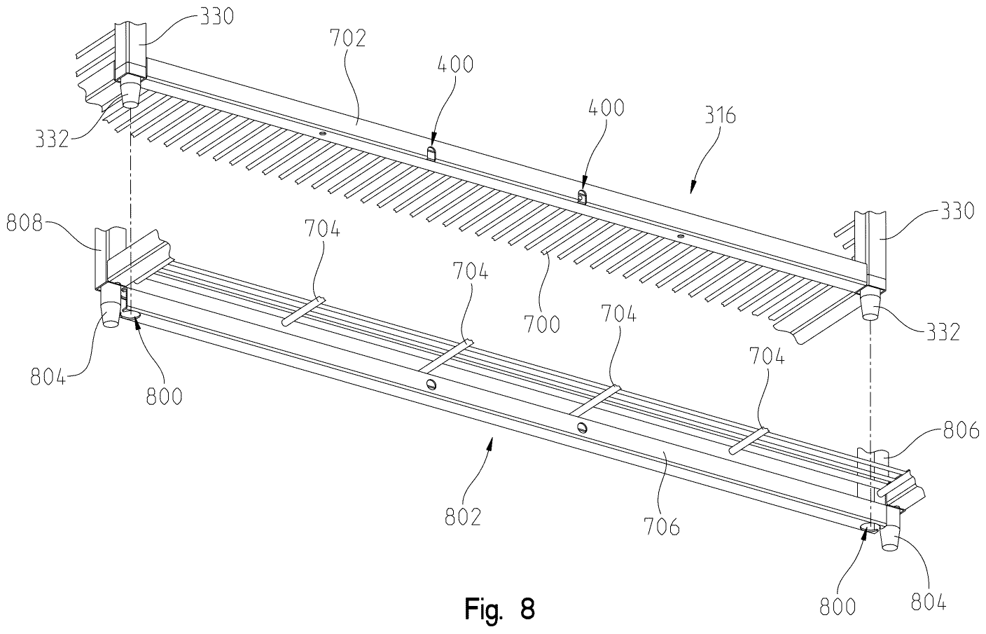

Referring to FIGS. 7 and 8 of the present disclosure, an implementation of the bottom member 316 of the enclosure assembly 300 is shown. Here, the bottom member 316 may include at least a first plurality of wires 700 and a second plurality of wires (not shown). The first plurality of wires 700 may be coupled to the support frame 330 of the bottom member 316. The support frame 330 may include at least a first support frame member 702. The support frame 330 may include one or more pegs 332 as shown in FIG. 8. The one or more pegs 332 may be received within one or more openings 800 formed in a second support frame member 706 of a second enclosure assembly 802. In some implementations, the second enclosure assembly 608 and the second enclosure assembly 802 may be the same. In other implementations, the second enclosure assembly 608 and the second enclosure assembly 802 may be different enclosure assemblies. In any event, the second enclosure assembly 802 may include a plurality of wires 704 as shown in FIGS. 7 and 8. Moreover, as shown in FIG. 8, the second enclosure assembly 802 may include a third support frame member 806 and a fourth support frame member 808. A peg 804 may protrude from each of the third support frame member 806 and fourth support frame member 808.

As shown in FIG. 7, two of the plurality of wires 704 are shown protruding through the openings 400 formed in the first support frame member 702. In other implementations, the first support frame member 702 may include one or more openings 400. In any event, the positioning of the wires 704 in the openings 400 further couples the enclosure assembly 300 to the second enclosure assembly 802.

In at least one implementation, a kit may include fasteners and the like for achieving the coupling between the different enclosures.

While exemplary implementations incorporating the principles of the present disclosure have been disclosed hereinabove, the present disclosure is not limited to the disclosed implementations. Instead, this application is intended to cover any variations, uses, or adaptations of the present disclosure using its general principles. Further, this application is intended to cover such departures from the present disclosure as come within known or customary practice in the art to which this disclosure pertains and which fall within the limits of the appended claims.

1. An animal enclosure assembly, comprising:
a plurality of members defining an interior of the enclosure, the plurality of members comprising at least a first member, a second member, a third member, and a fourth member, where the first member, second member, third member, and fourth member are at least partially formed by a plurality of interconnected first plurality and second plurality of wires; and
a door assembly movably coupled to one of the plurality of members and releasably coupled to another of the plurality of members;
wherein, each of the plurality of members includes a support frame formed by a plurality of support frame members;
wherein, at least one support frame member comprises a first end and a second end, the first end defining an opening configured to receive an end of another enclosure assembly and the second end forming a peg configured to being received by the another enclosure assembly.

2. The animal enclosure assembly of claim 1, wherein the first member comprises a U-shaped wire;
wherein the first plurality of wires of the first member comprises a first wire and a second wire, the first and second wires being parallel to one another;
wherein, the first wire and the second wire are coupled to the U-shaped wire.

3. The animal enclosure assembly of claim 2, wherein the first wire and second wire form the U-shaped wire.

4. The animal enclosure assembly of claim 2, wherein the U-shaped wire comprises a first bend coupled to the first wire, a second bend coupled to the second wire, and a transverse portion coupled between the first bend and the second bend.

5. The animal enclosure assembly of claim 4, wherein the first member comprises a first support frame member coupled to the first plurality of wires of the first member;
wherein, the U-shaped wire is located below the first support frame member.

6. The animal enclosure assembly of claim 5, wherein the transverse portion is located below and spaced outwardly from the first support frame member.

7. The animal enclosure of claim 4, wherein the transverse portion is perpendicular to the first wire and second wire.

8. The animal enclosure assembly of claim 2, wherein the first member comprises a second U-shaped wire;
wherein the first plurality of wires of the first member comprises a third wire and a fourth wire, the first and second wires being parallel to one another and the first and second wires;
wherein, the third wire and the fourth wire are coupled to the second U-shaped wire;
wherein the second U-shaped wire is spaced from the U-shaped wire.

9. The animal enclosure assembly of claim 8, wherein the third wire and fourth wire form the second U-shaped wire.

10. The animal enclosure assembly of claim 1, wherein the first member forms a top member, the second member forms a bottom member, the third member forms a first side member, and the fourth member forms a second side member;
wherein, the door assembly is movable between an open position and a closed position to selectively close a first opening formed by the top member, bottom member, first side member and second side member;
wherein, the top member, bottom member, first side member and second side member form a second opening, the first opening spaced from the second opening;
wherein an interior of the animal enclosure assembly is formed between the top member, bottom member, first side member, second side member, door assembly and second opening.

11. The animal enclosure assembly of claim 1, wherein the plurality of members comprises a fifth member coupled to the first member, second member, third member, and fourth member, the fifth member being spaced from the door assembly;
wherein, the fifth member defines an opening configured to being coupled to an interior of another enclosure assembly.

12. The animal enclosure assembly of claim 1, wherein the second member comprises a first support frame member, the first support frame member defining at least one opening configured to receive a wire of another animal enclosure.

13. The animal enclosure assembly of claim 12, wherein the first support frame member forms at least a second opening configured to receive a peg from the another animal enclosure.

14. The animal enclosure assembly of claim 1, wherein each of the plurality of interconnected first plurality and second plurality of wires is coupled to one or more of the plurality of support frame members of the support frame.

15. The animal enclosure assembly of claim 1, wherein the plurality of members form a breeder box assembly or a litter box assembly configured to being coupled to another animal enclosure.

16. An enclosure assembly, comprising:
an animal enclosure assembly comprising a first plurality of members including a top member, a bottom member, a first side member, a second side member, a front member, and a back member, the first plurality of members formed by a first plurality of interconnecting wires to define an interior of the animal enclosure assembly; and
a box enclosure assembly comprising a second plurality of members including at least a first member, a second member, a third member, a fourth member, and a door assembly member, where the second plurality of members are formed by a second plurality of interconnecting wires to define an interior of the box enclosure assembly;
wherein, each of the second plurality of members includes a support frame formed by a plurality of support frame members;
wherein, the box enclosure assembly is coupled to the animal enclosure assembly such that the interior of the box enclosure assembly is directly connected to the interior of the animal enclosure assembly.

17. The enclosure assembly of claim 16, wherein a first support frame member of the plurality of support frame members comprises a first end and a second end, the first end defining an opening configured to receive one of the first plurality of members of the animal enclosure assembly and the second end forming a peg configured to being received by an opening formed in another member of the first plurality of members of the animal enclosure assembly.

18. The enclosure assembly of claim 16, wherein the first member of the box enclosure assembly comprises a U-shaped wire;
wherein the first plurality of wires of the first member comprises a first wire and a second wire, the first wire and the second wire are coupled to the U-shaped wire;
wherein, one of the first plurality of members of the animal enclosure assembly is positioned on top of and in contact with the U-shaped wire when the box enclosure assembly is coupled to the animal enclosure assembly.

19. The enclosure assembly of claim 16, wherein the second member of the box enclosure assembly comprises a first support frame member, the first support frame member defining at least one opening configured to receive a wire of the animal enclosure assembly when the box enclosure assembly is coupled to the animal enclosure assembly.

20. The enclosure assembly of claim 19, wherein the first support frame member forms at least a second opening configured to receive a peg from the one of the first plurality of members of the animal enclosure assembly.
